(19) United States
(12) Patent Application Publication
(10) Pub. No.: US 2003/0148789 A1
(43) Pub. Date: Aug. 7, 2003

(54) Data handling telecommunication terminal

(76) Inventor: Kendro Hendra, Jakarta (ID)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/296,832

(22) PCT Filed: May 31, 2001
(86) PCT No.: PCT/IB01/01146

(30) Foreign Application Priority Data
May 31, 2000 (GB) 0013244.9

(51) Int. Cl. H04M 1/00

(52) U.S. Cl. 455/557; 455/418; 455/466

(57) ABSTRACT

The invention relates to video conference equipment comprising a document presentation worktop, actuators such as electric motors for the camera, control means for the actuators, for example a computer, audio equipment for saving and producing sound, a telecommunication module for forwarding audio data, and/or video information, and a display unit for displaying material filmed using the camera. A personal display unit and camera are reserved for at least one conference participant. The telecommunication module of the video conference equipment allows a data channel or a TCP/IP data channel or a corresponding data channel and the transmission of the MIDI signal of musical instruments as well as of signals controlling the pitch, intensity, duration with music synchronized with video images.

The present invention relates to apparatus and methods for personalising a telecommunication terminal. Today, it is very popular to have a personified ring tone generated by a transducer in a cellular phone, which alerts the user to an incoming call. Therefore, it is very common co hear an alerting signal, i.e. a ringing signal, in those parts of the world which supports a network for a telecommunication apparatus. For example, in Europe there is GSM, which is one example of a very common system used in networks. Since Europe has a lot of users, who receive a lot of calls, it becomes more and more difficult to distinguish the different apparatus, because many users uses/have the same alerting signal. This has become a huge problem. Because, when an apparatus is ringing, and there are many users around having the same alerting signal activated, these users will then most likely grab after their apparatus to discover that it was someone else's apparatus ringing. In particular, if a user is not expecting a call and has his/her hands occupied, it might become very annoying when an apparatus is rings, and the call was not even to him/her. Also, if somebody discovers a new alerting signal, which might be appreciated by other users, there is a possibility that it becomes so popular that it ends up with the same problem.

Further more, there is mostly no or small opportunity to alter the audible ringing or alerting signal so that, for example, a telephone generates a distinctive, audible alerting signal that is personalised to an individual user or group of users. Various telephone networks have, in some cases, a possibility to download alerting signals from a server provided by different service providers. However, in most cases the pattern of the audible ringing signal is usually limited to what has been placed on the server. There are also some telephones having a feature, which allows the individual user to compose his/her alerting signal. However, this feature is mostly very difficult to use for composing a tune, since the user usually has to define every note in the tune manually. By manually means that user may e.g. use the keypad on the phone to compose tie tune. similar problem occurs for graphical images, which can be used either to personalise the phone or for sending a picture message to another user. For example, it is possible to replace the default operator logo, indicating the network which the phone is connected to in idle mode. At present, there are a lot of software programs available for changing the operator name, by sending the logo as an SMS direct to the phone. It is also possible to personalise different group categories e.g. in the phone book of the phone, by connecting a particular graphic to a group of names, like family friends, business, etc This can be downloaded in a similar way as the operator logo. However, as in the case with ringing tones, the user usually has to define every pixel in the picture manually. It is possible to download different graphical images, but this means that the user is still restricted to these pictures which might be used by other users.

Therefore, there is a need to increase the degree of freedom to personalise the phone.

According to one aspect of the present invention, there is provided an arrangement, comprising a telecommunication terminal capable of being personalised with data, the telecommunication terminal including receiving means for receiving data, a computer device for transmitting data to the telecommunication terminal, said device comprising port means for connecting an external device, converting means for converting data into a format to be read by the terminal, and transmitter means to transmit data to said telecommunication terminal, and an external device, connected to said port means, to generate data to be converted by said converting means, and transmitted by said transmitter means to the terminal, in which said terminal is arranged to use said converted data for effecting personalisation

According to another aspect of the present invention, there is provided a method for handling data between a computer device and a telecommunication terminal, wherein the method comprises the following steps; connecting an external device to said computer device, generating data by means of said external device, receiving data by said computer device, converting said data into a format to be read by the terminal, and transmitting the converted data to the terminal, and using the converted data to personalise the terminal.

According to a still further aspect of the present invention, there is provided a telecommunication terminal for handling data, said terminal comprising port means for connecting an external device, converting means for converting data into a format to be read by the terminal, and means for using the converted data to personalise the terminal, wherein an external device for generating data to be converted by said converting means is connectable to said port means.

According to yet another aspect of the present invention, there is provided a method for handing data between an external device connected to a telecommunication terminal, wherein the method comprises the following steps: connecting an external device to said terminal, generating data by means of said external device receiving data by said terminal, converting said data into a format to be read by the terminal, and using said converted data to personalise the terminal.

For a better understanding of the present invention and to understand how the same may be brought into effect reference will now be made by way of example only to the accompanying drawings in which:

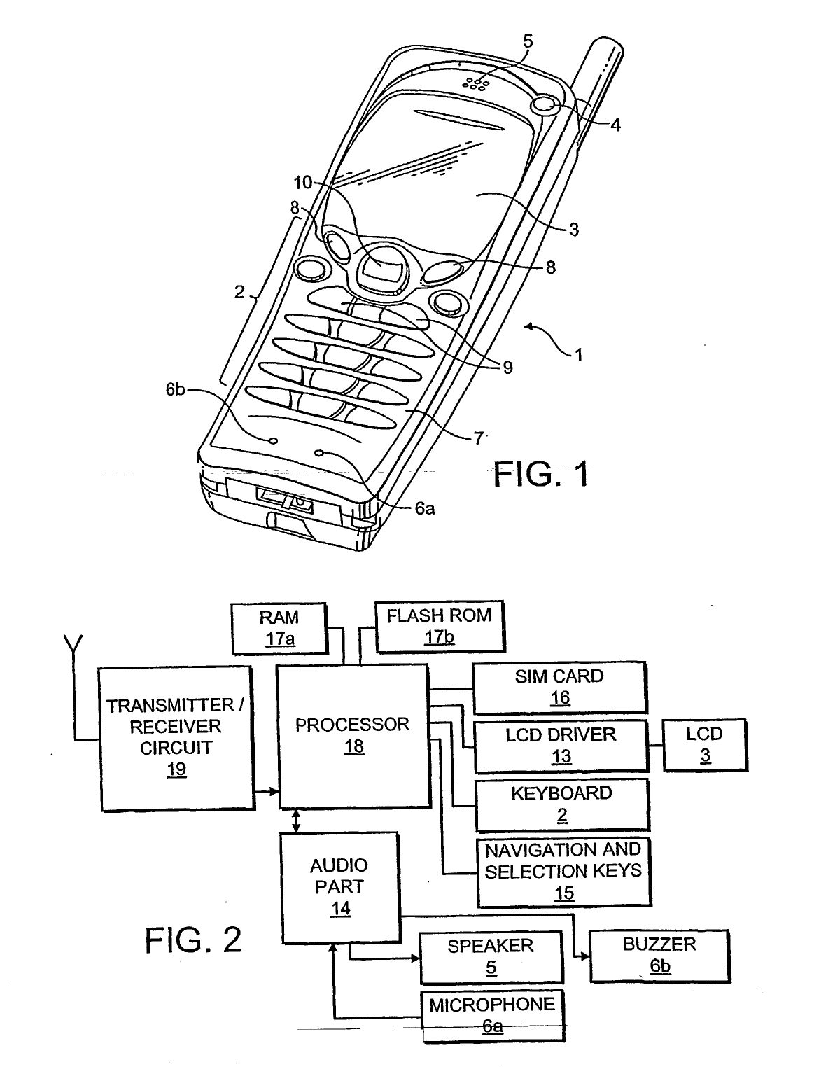

FIGS. 1 and 2 schematically illustrate a radio handset;

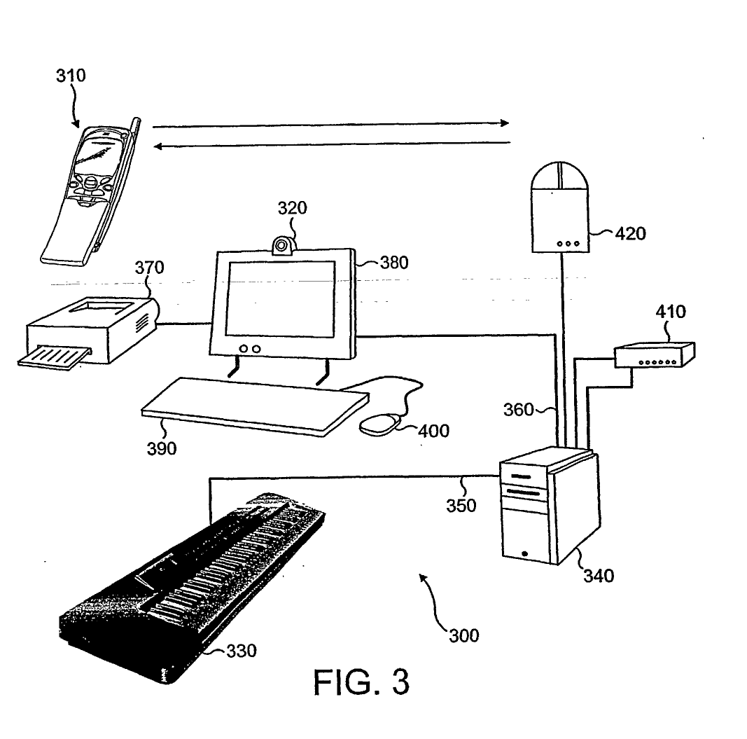

FIG. 3 schematically illustrates a system according to an embodiment of the present invention;

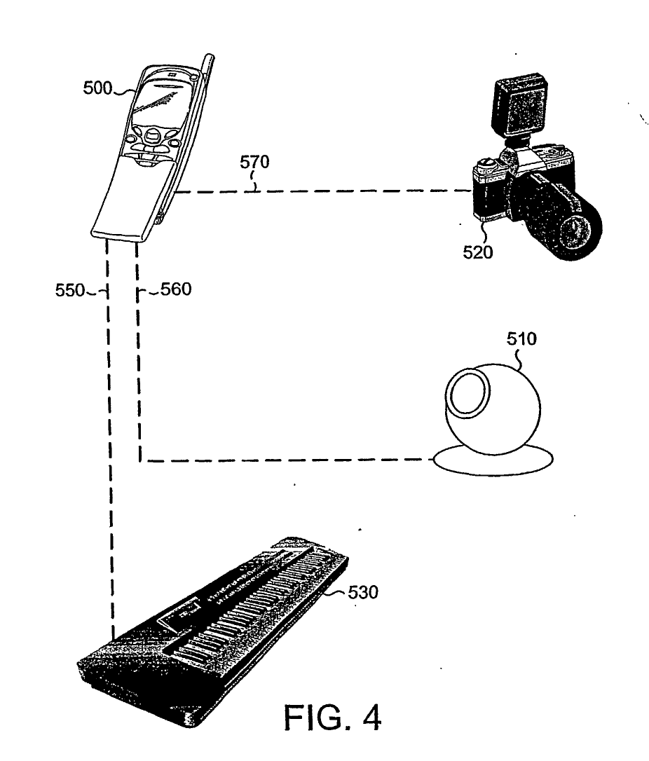

FIG. 4 schematically illustrates a phone connected to an external device according to an embodiment of the present invention;

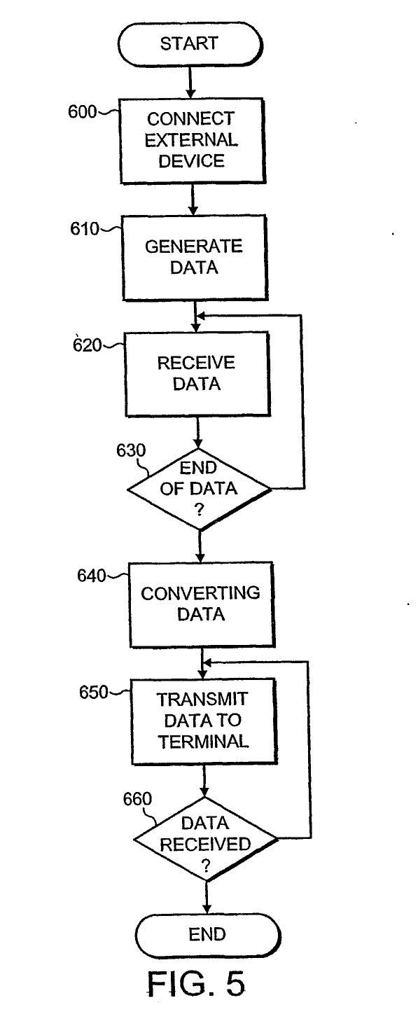

FIG. 5 is a flowchart illustrating one aspect of the present invention; and

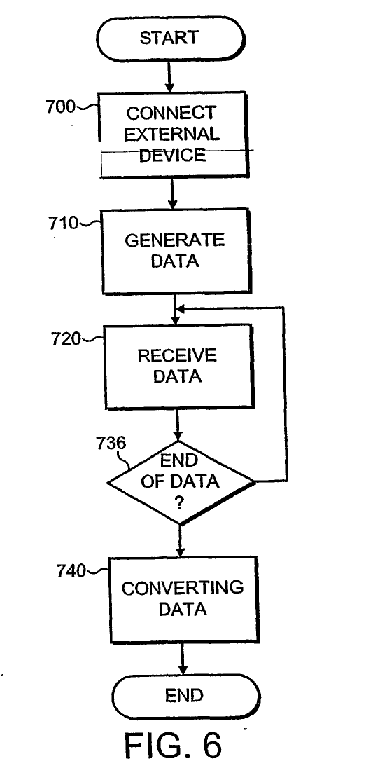

FIG. 6 is a flowchart illustrating another aspect of the present invention.

FIG. 1 shows a preferred embodiment of a terminal, hereafter also referred as a phone, according to the present invention. The phone, which is generally designated by 1, comprises a user interface having a keypad 2, a display 3, an on/off button 4, a speaker 5, a microphone 6a and a transducer 6b. The phone 1 according to the preferred embodiment is adapted for communication via a wireless telecommunication network, e.g. a cellular network. However, the phone could also have been designed for a cordless network. The keypad 2 has a first group 7 of keys as alphanumeric keys, by means of which the user can enter a telephone number, write a text message (SMS), write a name (associated with the phone number), etc. Each of the twelve alphanumeric keys 7 is provided with a figure “0-9” or a sign “#” or “*”, respectively. In alpha mode each key is associated with a number of letters and special signs used in text editing.

The keypad 2 additionally comprises two soft keys 8, two call handling keys 9, and a navigation key 10. he two soft keys 8 have a functionality corresponding to what is known from he phones Nokia 2110™, Nokia 8110™ and Nokia 3810™. The functionality of the soft key depends on the state of the phone and the navigation in the menu by using a navigation key. The present functionality of the soft keys 8 is shown in separate fields in the display 3 just above the keys 8.

The two call handling keys 9 according to the preferred embodiment are used for establishing a call or a conference call, terminating a call or rejecting an incoming call.

The navigation key 10 is an up/down key and is placed centrally on the front surface of the phone between the display 3 and the group of alphanumeric keys 7. Hereby the user will be able to control this key by simply pressing the up/down key using his/her thumb. Since many experienced phone users are used to one-hand control, it is a very good solution to place an input key, requiring precise motor movements. Thus, the user may place the phone in the hand between the finger tips and the palm of the hand. Hereby, the thumb is free for inputting information.

The transducer 6b could be a buzzer, and is arranged to generate a sound of a ring tone, upon reception of a signal from another phone, e.g. an incoming call or reception of an SMS (short messaging service) message.

FIG. 2 schematically shows the most essential parts of a preferred embodiment of the phone. These parts being essential to understand the invention. The preferred embodiment of the phone of the invention is adapted for use in connection with a GSM network, but, of course, the invention may also be applied in connection with other phone networks, such as other kinds of cellular networks and various forms of cordless phone systems or in dual band phones accessing sets of these systems/networks. The microphone 6a records the user's speech, and the analogue signals formed thereby are A/D converted in an A/D converter (not shown) before the speech is encoded in an audio part 14. The encoded speech signal is transferred to controller means 18, which may support software in the phone. The controller means 18 also forms the interface to the peripheral units of the apparatus, including a RAM memory 17a and a Flash ROM memory 17b, a SIM card 16, the display 3 and the keypad 2 (as well as data, power supply, etc.). The controller means 18 communicates with the transmitter/receiver circuit 19. The audio part 14 speech-decodes the signal, which is transferred from the controller 18 to the earpiece 5 via a D/A converter (not shown).

Also, the audio part 14 is also able to give an output of an ring tone to the buzzer 6b. The ring tone can be stored in either of the memories 17a,b, and is recalled when the receiver 19 receives an incoming signal, by means of the controller 18. Thus, the ring tone is recalled from the memory, forwarded to the audio part 14, and the ring tone is generated as an output from the buzzer 6b.

The controller means 18 is connected to the user interface. Thus, it is the controller means 18 which monitors the activity in the phone and controls the display 3 in response thereto.

Therefore, it is the controller means 18 which detects the occurrence of a state change event and changes the state of the phone and thus the display text. A state change event may be caused by the user when he activates the keypad including the navigation key 10, and these type of events are called entry events or user events. However, the network communicating with the phone may also cause a state change event. This type of event and other events beyond the user's control are called non user events. Non user events comprise status change during call set-up, change in battery voltage, change in antenna conditions, message on reception of SMS, etc.

FIG. 3 shows a system 300 for generating data to be handled by a telecommunication terminal 310. The terminal 310 has corresponding functions as the terminal of FIG. 1, and is in this embodiment a cellular phone. The data is generated by an external device, which in a preferred embodiment could be a camera 320 and/or an instrumental keyboard 330. The camera 320 could for example be a digital camera, a webcam, or even a scanner. The instrumental keyboard 330 could for example be a MIDI keyboard.

The external device(s) 320, 330 is connected to a computer device 340. The computer device is provided with port means, wherein the external device is connected to said port means 350, 360 to generate data. The port means can be a standard port on a computer for connecting external devices to, e.g. an RS232 port and/or a midi/joystick port. The port means could also provide a wireless connection to the external devices, e.g. via a low-power RF device like a blue tooth application. Other external devices, than an instrumental keyboard 330 and a camera 320, like a printer device 370, display means 380, a keyboard 390, and a computer mouse 400 can be connected to the computer.

If it is picture data which is generated by the external device, the computer device is able select an area of the picture. The area of the picture can be pre-defined, e.g. like 72×28 pixels, 84×48 pixels and 96×65 pixels. If it is audio data which is generated by the external device, the computer device might be able to trap the keyboard events of the instrumental keyboard, i.e. detect when a key is pressed and when it is released and determine which key was pressed. Then the length of the note corresponding to the key can be calculated and it can also be determined if there is any pause in between the successive depression of keys corresponding to a. rest.

The computer device 340 also comprises converting means (not shown) for converting data into a format to be read by the telecommunication terminal 310. If it is picture data which is generated by the external device, the computer device might be able to convert the picture from colour or black and white to a grey scale with dithering, convert it to a one-bit black and white picture, and allow the user of the computer device to adjust the threshold of he picture. If it is audio data which is generated by the external device, the computer device might be able to convert audio data into a ringtone format. Transmitter means 410, 420 is also connected to the computer or integrated therein, which is arranged to transmit data to the telecommunication terminal. Thus, in accordance with the present invention, before the transmitting the data generated by the external device 320,330 through the transmitter means 410,420, the data is converted by the converting means. The transmitter means could typically be a modem device 410, or/and a Nokia PremiCell terminal 420. A Nokia PremiCell terminal is a wireless communication terminal which can be connected to a GSM network and provides means for connecting conventional fixed line telephony equipment to a GSM network. Thus in the present case, the computer device 340 is connected to the Nokia PremiCell terminal 420 The Nokia PremiCell terminal 420 sends calls through the GSM network and no fixed line is needed. Consequently, the computer device 340 is able, via the connection provided to the GSM network by the Nokia PremiCell Terminal 420, to send converted data to the terminal 310.

There are many different ways of transmitting the converted data to the terminal, e.g. it could be transmitted as SMS message (Short Messaging Service). Alternatively, the converted data could be pushed to the phone by using WAP (Wireless Application Protocol) technology. A push in WAP could be described as the computer device have the address data which is necessary to transfer the converted data to the terminal, without requiring any user interaction. WAP is a result of continuous work to define an industry wide standard for developing applications over cellular communication networks. This makes it possible to access for example the Internet or other kinds of information networks provided with hypermedia servers, from an ordinary cellular phone supporting WAP.

FIG. 4 shows a telecommunication terminal for handling data. The terminal 500 has corresponding functions as the terminal of FIG. 1, and is in this embodiment a cellular phone. The data is generated by an external device, which in a preferred embodiment could be a digital camera 510, 520 and/or an instrumental keyboard 530. The external device(s) 510, 520, 530 are connected to the terminal 500. The terminal is provided with port means, wherein the external device is connected to said port means 550, 560, 570 to generate data. The port means can be in form of an electrical connector with an interface enabling communication between the terminal and the external device. The port means could also provide a wireless connection to the external devices, e.g. via a low-power RF device like a blue tooth application or by means of an infra-red transceiver. It could also be possible to connect other external devices, than an instrumental keyboard 530 and a camera 510, 520, like a printer device or a monitor can be connected to the computer.

The telecommunication terminal 500 also comprises converting means (not shown) for converting data into a format to be read by the terminal. Thus, in accordance with the present invention, the external device is connected to the port means to generate data to be converted by said converting means.

FIG. 5 illustrates a method for handling data between a computer device and a telecommunication terminal, as disclosed in Fig. 3. First, an external device is connected to the computer device 600. This external device generates data 610, which in a preferred embodiment could be a picture data and/or audio data. These data can be generated by a digital camera and an instrumental keyboard, respectively. The computer device is provided with port means, wherein the external device is connected to the port means to generate data which is received by the port means 620. The data is received by the port means, until the computer device is detecting the end of the data 630. The port means can be a standard port on a computer for connecting external devices to, e.g. an RS232 port. The port means could also provide a wireless connection to the external devices, e.g. via a low-power RF device like a blue tooth application.

The computer device also comprises converting means which converts the data into a format to be read by the telecommunication terminal 640. If it is picture data to be converted, it can be preferably converted into an operator logo format, group graphics format, and/or picture messaging format. If it is audio data, it can be preferably converted into a ringing tone format. Transmitter means is also connected to the computer or integrated therein, which transmits data to the telecommunication terminal 650. This step can be repeated until the terminal acknowledge that the converted data is received 660. Thus, in accordance with the present invention, before the transmitting the data generated by the external device through the transmitter means, the data is converted by the converting means. The transmitter means could typically be a modem device.

FIG. 6 illustrates a method for handling data between an external device connected to a telecommunication terminal, as disclosed in FIG. 4. First, an external device is connected to the terminal 700. This external device generates data 710, which in a preferred embodiment could be a picture data and/or audio data. These data can be generated by a digital camera and an instrumental keyboard, respectively. The terminal is provided with port means, wherein the external device is connected to the port means to generate data which is received by the port means 720. The data is received by the port means, until the terminal detects the end of the data 730. The port means could be a wireless connection to the external devices, e.g. via a low-power RF device like a blue tooth application.

The terminal also comprises converting means which converts the data into a format to be read by the telecommunication terminal 740. If it is picture data to be converted, it can be preferably converted into an operator logo format, group graphics format, and/or picture messaging format. If it is audio data, it can be preferably converted into a ringing tone format. Thus, in accordance with the present invention, the data is converted by the converting means, to be handled by the terminal.

Although the invention has been described with respect to a particularly preferred embodiment, it should be appreciated that the invention as defined by the claims extends beyond the particular features of the embodiment described to encompass modifications and variations to the embodiment not necessarily described. For example, instead of using the present invention on a telecommunication terminal, like a cellular phone, it could be used on other types of handheld devices, like a personal digital assistant (PDA).

1. An arrangement, comprising:
a telecommunication terminal capable of being personalised with data, the telecommunication terminal including receiving means for receiving data, a computer service for transmitting data to the telecommunication terminal, said device comprising:
port means for connecting an external device;
converting means for converting data into a format to be lead by the terminal; and
transmitter means to transmit data to said telecommunication terminal; and
an external device, connected to said port means, to generate data to be converted by said converting means, and transmitted by said transmitter means to the terminal,
in which said terminal is arranged to use said converted data for effecting personalisation.

2. An arrangement according to claim 1, wherein said external device is a camera.

3. An arrangement according to claim 1, wherein said external device is an instrumental keyboard.

4. A method for handling data between a computer device and a telecommunication terminal, wherein the method comprises the following steps:
connecting an external device to said computer device,
generating data by means of said external device,
receiving data by said computer device,
converting said data into a format to be read by the terminal, and
transmitting the converted data to the terminal; and
using the converted data to personalise the terminal.

5. A method according to claim 4, wherein the generating of data is picture data.

6. A method according to claim 5, wherein the picture data is converted into one or more of an operator logo format, group graphics format, and/or picture messaging format.

7. A method according to claim 4, wherein the generating of data is audio data.

8. A method according to claim 7, wherein the audio data is converted into a ringing tone format.

9. A method according to claim 4, wherein the converted data is transmitted as an SMS.

10. A telecommunication terminal for handling data, said terminal comprising:
port means for connecting an external device,
converting means for converting data into a format to be read by the terminal, and
means for using the converted data to personalise the terminal,
wherein an eternal device for generating data to be converted by said converting means is connectable to said port means.

11. A terminal according to claim 10, wherein said external device is a camera.

12. A terminal according to claim 10, wherein said external device is an instrumental keyboard.

13. A terminal according to claim 10, wherein said terminal is a cellular phone.

14. A method for handling data between an external device connected to a telecommunication terminal, wherein the method comprises the following steps:
connecting an external device to said terminal,
generating data by means of said external device,
receiving data by said terminal,
converting said data into a format to be read by the terminal, and
using said converted data to personalise the terminal.

15. A method according to claim 14, wherein the generating of data is picture data.

16. A method according claim 15, wherein the picture data is converted into one or more of an operator logo format, group graphics format, and/or picture messaging format.

17. A method according to claim 14, wherein the generating of data is audio data.

18. A method according to claim 17, wherein the audio data is converted into a ringing tone f0ormat.
